(19) United States
(12) Patent Application Publication
(10) Pub. No.: US 2012/0118657 A1
(43) Pub. Date: May 17, 2012

(54) Motorized Golf Bag Cart

(76) Inventor: Gordon Liao, Yung Kang City (TW)

(21) Appl. No.: 12/947,930

(22) Filed: Nov. 17, 2010

(51) Int. Cl. B62D 51/04

(52) U.S. Cl. 180/208

(57) ABSTRACT

A motorized golf bag cart includes a base frame, a lower frame and an upper frame. The base frame has a front wheel rotatable base set at two sides of the front side respectively for installing a front wheel able to spin freely, a battery set at the rear side, a connecting base formed at two sides of the rear side respectively, a motor positioned outwardly next to the connecting base, and two direction-oriented rear wheels connected outwardly with the motor. The lower frame is pivotally connected with the connecting base outwardly, provided with a positioning member located at two sides of the bottom respectively, and a folding joint installed at the top. The upper frame has a lower end connected with the folding joint, a rotatable joint and a handle bar set at the top and having a power switch and a speed controller etc, to direct the cart.

### BACKGROUND OF THE INVENTION

1. Field of the Invention

This invention relates to a motorized golf bag cart, particularly to one that is collapsible and able to be connected with a driver carriage, with convenience for storing, carrying and using.

2. Description of the Prior Art

Commonly, a conventional motorized golf bag cart disclosed in U.S. Pat. No. 7,537,076, is provided with a frame 12 and a seat 16, which cannot be folded so as to make the cart having a rather big size, inconvenient for storing and carrying about. This is the first defect. As two rear wheels 20 are configured to travel in certain direction while the cart is switched to manual mode, it counts on rotation of a front steering wheel 18 assembled at a lower portion of a handle bar to change traveling direction of the cart. However, it would confuse a user as the front steering wheel 18 has to be turned right if the cart is expected to turn left, and vice versa, exactly contrary to general custom. Moreover, in case that the cart is moved up a slope by manpower because of being of power exhaust of a battery, as the front wheels 18 under the handle has to go up the slope in the same direction of the rear wheels 30, the body is apt to swing with the steering assembly 14 owing to the front portion of the body tending to divide the force, in spite of the handle being restricted in turning around.

### SUMMARY OF THE INVENTION

The object of this invention is to offer a collapsible motorized golf bag cart with a contracted bulk convenient for storing and carrying.

Another object of this invention is to offer a collapsible motorized golf bag cart permitting to be connected with a driver carriage for a user to ride instead of walking.

The main characteristics of the invention are a base frame, a lower frame and an upper frame. The base frame has a front wheel rotatable base set at two sides of the front side respectively for installing a front wheel able to spin freely, a battery set at the rear side, a connecting base formed at two sides of the rear side respectively, a motor positioned outwardly next to the connecting base, and two direction-oriented rear wheels connected outwardly with the motor. The lower frame is pivotally connected with the connecting base outwardly, provided with a positioning member located at two sides of the bottom respectively, and a folding joint installed at the top. The upper frame has a lower end connected with the folding joint, a joint and a handle bar set at the top. The handle bar is provided with a power switch and a speed controller etc, so as to direct the cart.

### BRIEF DESCRIPTION OF DRAWINGS

This invention is better understood by referring to the accompanying drawings, wherein:

FIG. 1 is a perspective view of a preferred embodiment of a motorized golf bag cart in the present invention;

FIG. 2 is a side view of the preferred embodiment of a motorized golf bag cart in the present invention;

FIG. 3 is an exploded perspective view of a motor and a rear wheel in the present invention;

FIG. 4 is a cross-sectional view of the motor and the rear wheel assembled together in one state in the present invention;

FIG. 5 is a cross-sectional view of the motor and the rear wheel assembled together in another state in the present invention;

FIG. 6 is an illustrating view of a lower frame and a positioning member in the present invention, showing them being unfolded;

FIG. 7 is an illustrating view of the lower frame and the positioning member in the present invention, showing them being folded;

FIG. 8 is a perspective view of the preferred embodiment of a motorized golf bag cart in the present invention, with an upper frame exploded;

FIG. 9 is a perspective view of the preferred embodiment of a motorized golf bag cart in the present invention, with a driver carriage explicitly stated;

FIG. 10 is a side view of the preferred embodiment of a motorized golf bag cart in the present invention, showing how it being folded;

FIG. 11 is a side view of the preferred embodiment of a motorized golf bag cart in the present invention, showing it being totally folded up;

FIG. 12 is an illustrating view of the preferred embodiment of a motorized golf bag cart in the present invention, showing it is motorized, traveling with a user riding on the driver carriage;

FIG. 13 is an illustrating view of the preferred embodiment of a motorized golf bag cart in the present invention, showing it is electrically traveling with a user walking; and

FIG. 14 is an illustrating view of the preferred embodiment of a motorized golf bag cart in the present invention, showing it is absolutely pushed by a user manually.

### DETAILED DESCRIPTION OF THE PREFERRED EMBODIMENT

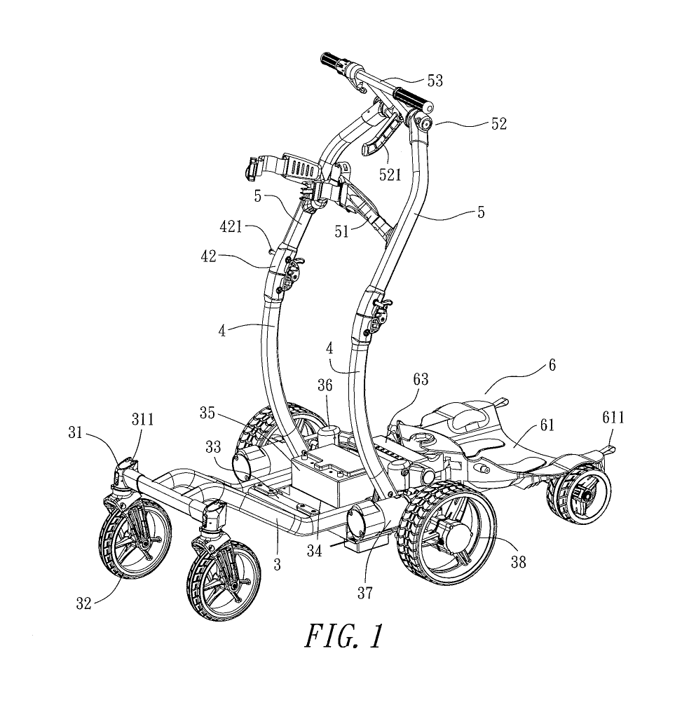

As shown in FIGS. 1˜9, a preferred embodiment of a motorized golf bag cart in the present invention includes a base frame 3, a lower frame 4, an upper frame 5 and a driver carriage 6.

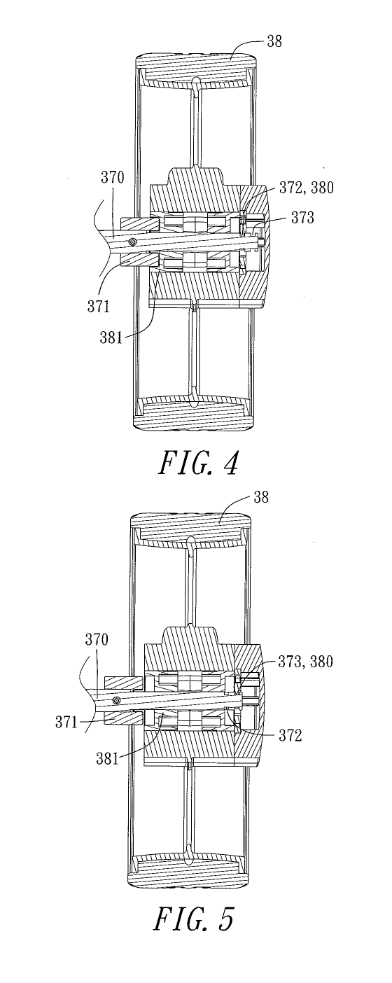

The base frame 3 is provided with a front-wheel rotatable base 31 set at two sides of the front respectively, with a concaved surface 311 formed in the inner side of the rotatable base 31. Two front wheels 32 are assembled under the rotatable base 31, able to rotate freely. The base frame 3 is also provided with a bag base 33 located at the intermediate portion, a battery groove 34 set at the rear portion for loading a battery 35, a connecting base 36 formed at two sides of the rear respectively, a motor 37 positioned outwardly next to the connecting base 36, and two direction-oriented rear wheels 38 connected outwardly with the motor 37. The motor 37 is provided with a shaft 370 that is mounted with a clutch 371 and cut with an inner fixing groove 372 and an outer fixing groove 373 around the free end. The rear wheels 38 are provided with a button 380 and a clutch 381. with the button 380 locked with the inner fixing groove 372 and with the clutch 381 engaged with the clutch 371 under normal condition, so that the rear wheels 38 can be driven by the motor 37, as shown in FIG. 4.

With the button 380 locked with the inner fixing slot 372 and with the clutch 381 engaged with the clutch 371, the rear wheels 38 can be electrically driven by the motor 37 normally, as shown in FIG. 4. On the contrary, if the cart is to be moved by manpower, the button 380 can be pressed down to enable the rear wheels 38 being axially pulled outward slightly to lock with the outer groove 373, with the clutch 381 detached from the clutch 371 so as to keep the rear wheels 38 free from the motor 37, as shown in FIG. 5. And the rear wheels 38 can be further pulled outward to completely separate from the shaft 370 while the button 380 is pressed down again.

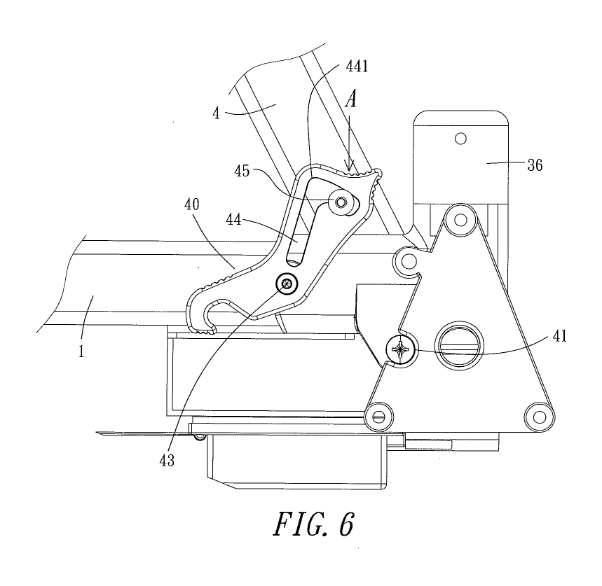

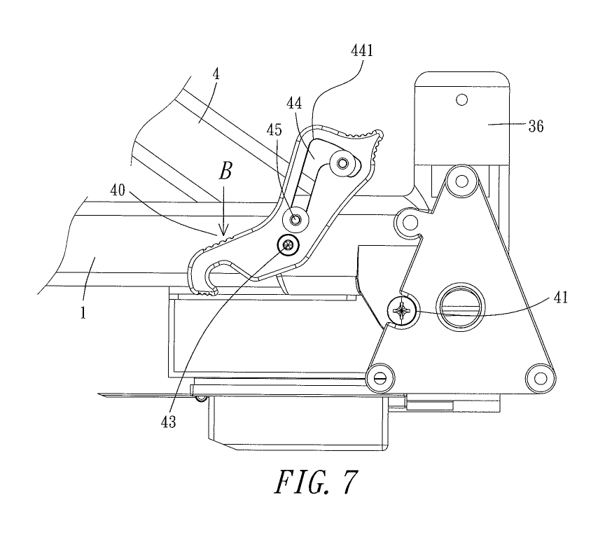

The lower frame 4 is pivotally connected with the connecting base 36 outwardly by means of an axle 41 set at the bottom. Formed at the top of the lower frame 4 is a folding joint 42 provided with a projecting bar 421 extended outward. The lower frame 4 is further provided with a positioning member 40 located at two sides of the bottom respectively for making the lower frame 4 fixedly positioned while folded or unfolded. By means of an axle 43 installed in the intermediate portion of the positioning member 40, the positioning member 40 is pivotally connected with the base frame 3. A sliding slot 44 is cut in the upper portion of the positioning member 40, employed to confine a projecting axle 45. When the lower frame 4 is to be folded, the positioning member 40 is first pressed down at the top (as arrowed by “A” in FIG. 6) to make the projecting axle 45 move to a top end 441 of the sliding slot 44; next, the lower frame 4 is pushed inward and downward to rotate down by means of the axle 41 functioning as a pivot. At the same time, the projecting axle 45 can also move to the rear end of the sliding slot 44, with the lower frame 4 contacting with the concaved surface 311 of the base frame 3; thus the lower frame 4 is totally folded up as shown in FIG. 7. Oppositely, if the lower frame 4 is to be unfolded or extended up, the lower frame 4 is first pulled up to make the projecting axle 45 moved to the top end 441 of the sliding slot 44; then the positioning member 40 is pressed down at the bottom as arrowed by “B” in FIG. 7, so as to move the projecting axle 45 to the front end of the sliding slot 44; thus the lower frame 4 is totally unfolded as shown in FIG. 6.

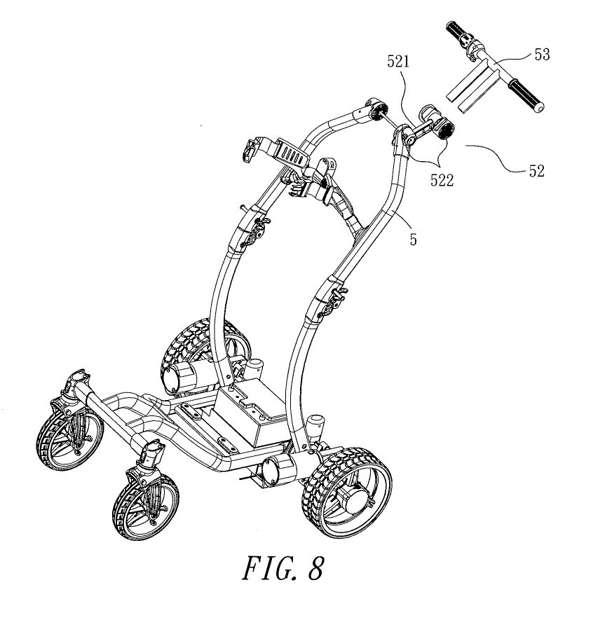

The upper frame 5 has the lower end connected with the folding joint 42 that is able to keep the lower frame 4 and the upper frame 5 fixed in a certain angle. The upper frame 5 is provided with an upper bag support 51 located at the intermediate portion, a rotatable joint 52 and a handle bar 53 formed at the top. As shown in FIG. 8, the rotatable joint 52 is composed of a grip 521 and a gear plate assembly 522. When the grip 521 is pulled forward (downward), the gear plate assembly 522 can be disengaged so that the rotatable joint 52 can be rotated to change its angle. And if the grip 52 is reversely moved backward (upward), the gear plate assembly 522 is to be engaged again so as to keep the rotatable joint 52 fixed tightly in the needed angle. The handle bar 53 is provided with a power switch, a speed controller employed to control traveling speed of the cart running forward or backward, and a brake.

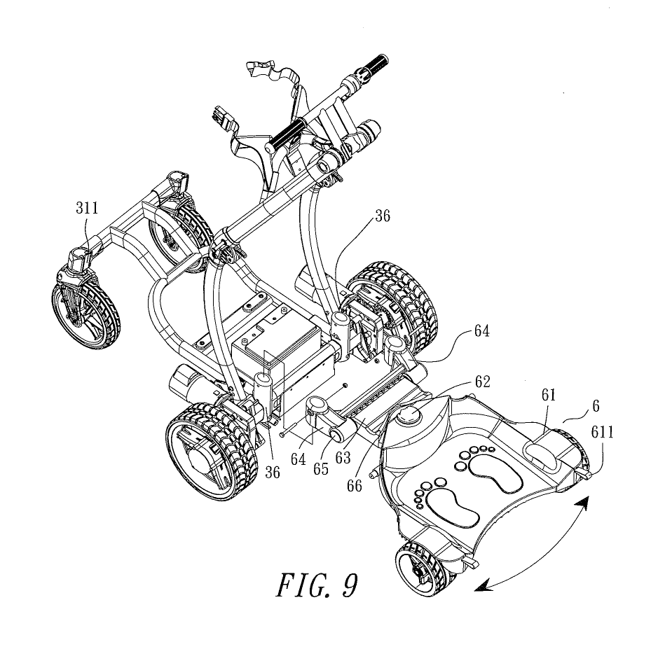

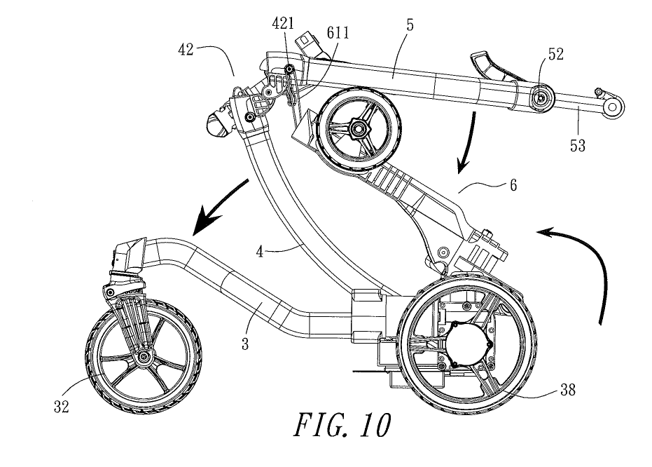

The driver carriage 6 is installed behind the base frame 3, connected with the connecting base 36. As shown in FIG. 9, the driver carriage 6 is provided with a skateboard 61, an axle 62 set in the front side, and a skateboard base 63 pivotally connected with the axle 62. The skateboard 61 has an elastic mounting sleeve 611 fixed at two sides of the rear side respectively, able to swing with respect to the axle 62. The skateboard base 63 has two sides of the front side respectively installed with a mounting base 64 for fixedly connecting with the connecting base 36. Set at the intermediate portion of the skateboard base 63 is an axle 65 enabling the skateboard 61 to be swung left and right while being upwardly folded up. The mounting sleeve 611 can be hung on the projecting bar 421, as shown in FIG. 10. The skateboard base 63 has the rear side formed as a concaved surface 66 utilized to keep the skateboard 61 swinging securely.

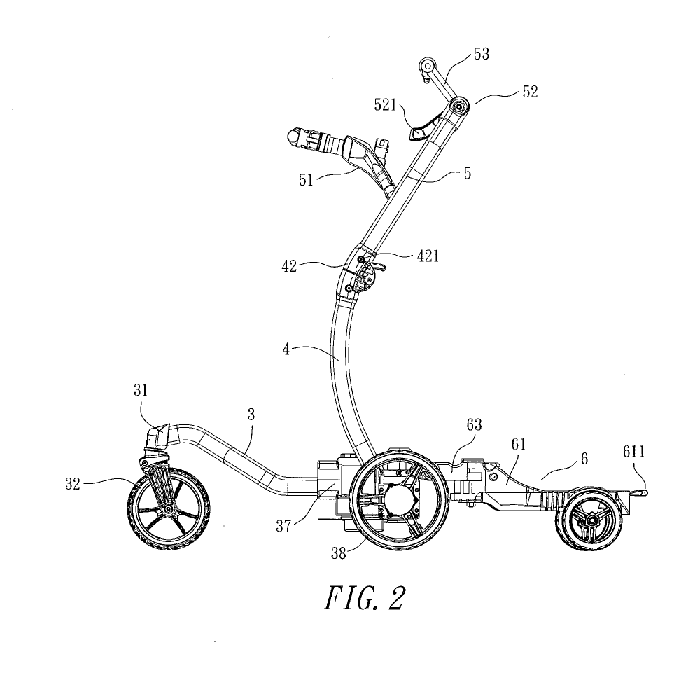

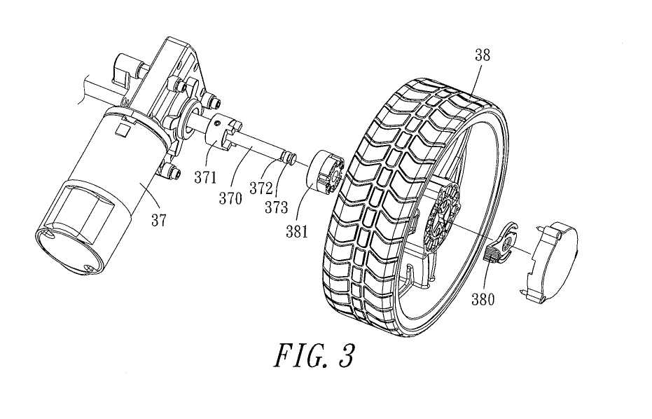

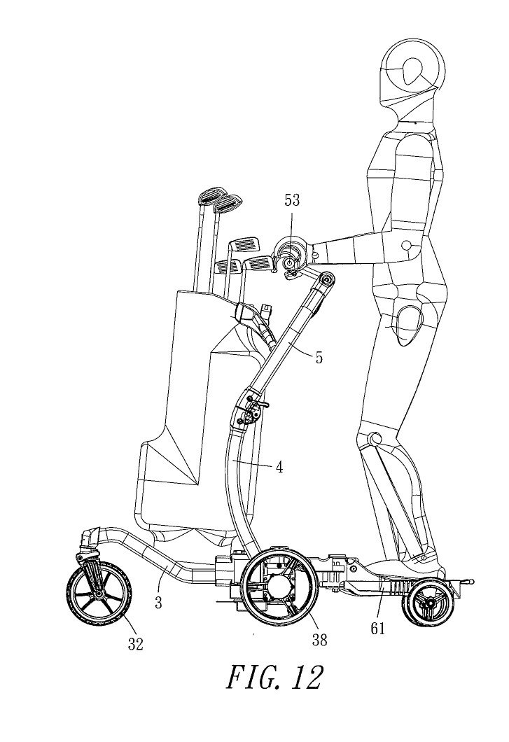

FIGS. 1 and 2 show the cart is unfolded in a regular mode, with a user standing on it. The lower frame 4 is positioned in place by the positioning member 40, as shown in FIG. 6. The handle bar 53 is properly leveled by adjusting the joint 52. The skateboard 61 is connected behind the base frame 3, flatly laid on the ground. The motor 37 can drive the rear wheel 38 to move, as shown in FIG. 4. FIG. 12 shows a user rides on the skateboard 61, with two hands grasping the handle bar 53 to control the power switch and the speed controller. And a user can directly control the handle bar 53 as usually to make the front wheels 32 turn right or left, directing the way for the cart.

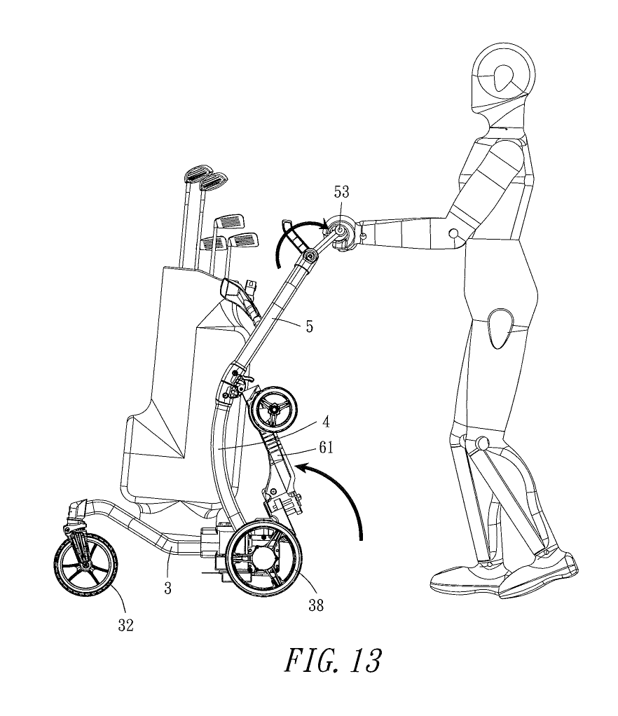

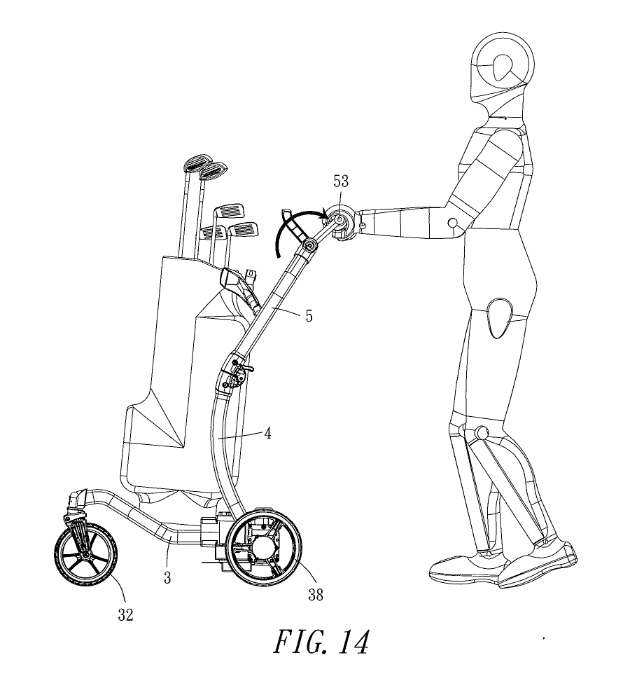

If necessary, the skateboard 61 can be folded up and positioned behind the lower frame 4, and by adjusting the joint 52, the handle bar 53 can be moved backward to a proper level, enabling a user to stand behind the cart holding the handle bar 53 to electrically direct the cart, as shown in FIG. 13. This is another mode of the cart motorized, but with a user walking behind the cart.

In case that the battery 35 is unloaded or used up of its power, the rear wheels 38 can be slightly pulled outward to free from linking with the motor 37, as shown in FIG. 5. By the time, a user can also grasp the handle bar 53 to easily push the cart with manually. It is a mode with manpower.

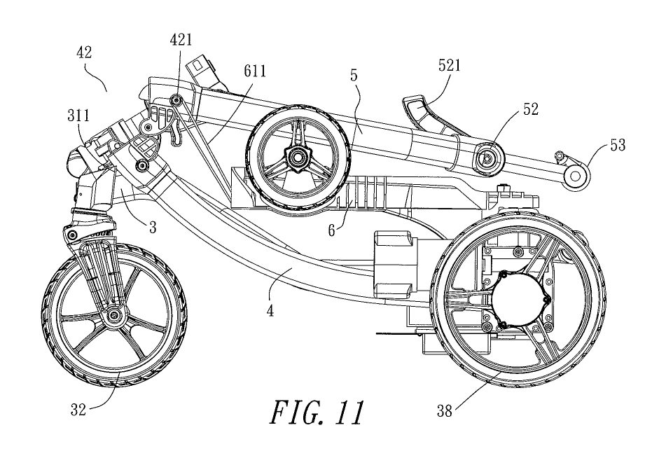

In folding the cart, the skateboard 61 is first pulled up and positioned behind the lower frame 4. Next, the positioning member 40 is released so as to make the lower frame 4 folded both forwardly and downwardly, as shown in FIG. 7. Then the folding joint 42 is detached with itself so that the upper frame 5 can be pushed back to closely lie on the lower frame 4, as shown in FIG. 10. Thus, as shown in FIG. 11, the cart is completely folded up.

On the contrary, when the cart is to be unfolded, the upper frame 5 is first pulled both upward and forward, with the folding joint 42 positioned to correspond to that of the lower frame 4. The lower frame 4 is successively pulled both upward and backward. The positioning member 40 is then pressed to a position corresponding to the base frame 3, as shown in FIG. 6. Finally the skateboard 61 is released from the lower frame 4 to turn down to the ground, as shown in FIGS. 1 and 2. The cart is thus unfolded, ready to be used.

The invention has the following advantages as can be seen from the foresaid description.

1. In golf links, the cart of the invention can be generally used to carry the golf bag or a rider only.

2. With the skateboard 61 pulled up or laid down and the handle bar 53 adjusted to a proper level, the cart can be swiftly interchanged as a riding mode and a manpower mode.

3. If the cart is not installed with the driver carriage 6 (skateboard 61), it is also a motorized golf bag cart controlled by hands, providing more option to attract buyers.

4. As the cart is collapsible, it is convenient for storing and delivering.

5. Unlike the conventional cart mentioned previously, the cart of the invention does not cause directional errors while making a turn. And when the cart is moved up a slope, the handle bar 53 can be prevented from swinging by the lack of the downward force of the front portion of the body as the front wheels 32 can spin freely and the rear wheels 38 are direction-oriented.

6. By replacing the bag base 33 with a platform or a basket, the cart of the invention can be converted into a luggage cart usable in the airport or in the supermarkets.

While the preferred embodiment of the invention has been described above, it will be recognized and understood that various modifications may be made therein and the appended claims are intended to cover all such modifications that may fall within the spirit and scope of the invention.

What is claimed is:

1. A motorized golf bag cart comprising:
a base frame provided with a front wheel rotatable base set at two sides of a front side respectively, two front wheels assembled under said rotatable base and able to spin freely, a battery set at a rear side of said base frame, a connecting base formed at two sides of a rear side of said base frame respectively, a motor positioned outwardly next to said connecting base, two direction-oriented rear wheels connected outwardly with said motor;
a lower frame pivotally connected with said connecting base outwardly, a positioning member located at two sides of a bottom of said lower frame respectively, a folding joint installed at a top of said lower frame; and
an upper frame having a lower end connected with said folding joint, a rotatable joint and a handle bar set at a top of said upper frame, said handle bar provided with a power switch and a speed controller.

2. The motorized golf bag cart as claimed in claim 1, wherein said front wheel rotatable base is provided with a concaved surface formed in an inner side.

3. The motorized golf bag cart as claimed in claim 1, wherein said, folding joint has a projecting bar fixed at an outside.

4. The motorized golf bag cart as claimed in claim 1, wherein said positioning member is pivotally connected with said base frame and provided with a sliding slot cut in an upper portion for confining a projecting axle to move therein.

5. The motorized golf bag cart as claimed in claim 1, wherein a driver carriage is connected with said connecting base at a rear end of said base frame.

6. The motorized golf bag cart as claimed in claim 5, wherein said driver carriage is a skateboard assembly including a skateboard having a front end pivotally connected with a skateboard base that has two sides of a front side respectively installed with a mounting base and a rear side formed as a concaved surface.

7. The motorized golf bag cart as claimed in claim 6, wherein said skateboard is provided with an elastic mounting sleeve set at two sides of a rear side respectively.
